(19) United States
(12) Patent Application Publication
(10) Pub. No.: US 2026/0302633 A1
(43) Pub. Date: Oct. 1, 2026

(54) ANTENNA MODULE AND COMMUNICATION DEVICE

(71) Applicant: Arizon RFID TECHNOLOGY (HONG KONG) CO., LTD., Wanchai (HK)

(72) Inventor: Chi-Keong Wong, Wanchai (HK)

(73) Assignee: Arizon RFID TECHNOLOGY (HONG KONG) CO., LTD., Wanchai (HK)

(21) Appl. No.: 19/578,147

(22) Filed: Mar. 25, 2026

(30) Foreign Application Priority Data
Mar. 28, 2025 (TW) 114112204

(51) Int. Cl. H01Q 13/10

(52) U.S. Cl. CPC H01Q 13/10

(57) ABSTRACT

An antenna module includes a substrate, a radiation part, and a ground part. The substrate includes a first surface and a second surface opposite to each other. The radiation part is located on the first surface of the substrate. The radiation part includes a first feed point, a second feed point, and four slots. The first feed point and the second feed point are respectively located in a two-dimensional axis direction of the radiation part. Two adjacent ones of the four slots are symmetrical to each other. The ground part is located on the second surface of the substrate.

### CROSS-REFERENCE TO RELATED APPLICATION

This non-provisional application claims priority under 35 U.S.C. § 119(a) to Patent Application No. 114112204 filed in Taiwan, R.O.C. on Mar. 28, 2025, the entire contents of which are hereby incorporated by reference.

### TECHNICAL FIELD

The present invention relates to the communications field, and in particular, to an antenna module and a communication device.

### RELATED ART

In a radio-frequency identification (Radio-frequency identification, RFID) technology, a radio-frequency reader/writer can effectively identify a radio-frequency tag and obtain information of the radio-frequency tag, to be applied to an operating environment in a workplace such as a retail industry and a warehouse and storage industry. The radio-frequency reader/writer is usually implemented by using a communication device and has an antenna built in. The antenna is usually a circularly polarized antenna or a linearly polarized antenna. Because the circularly polarized antenna can receive wireless signals from radio-frequency tags in a plurality of directions, the circularly polarized antenna can be applied to a scenario in which the radio-frequency tags are located in a plurality of different directions. Because the linearly polarized antenna can be polarization-matched to the radio-frequency tag, the linearly polarized antenna can enhance a read/write distance between the radio-frequency reader/writer and the radio-frequency tag, so that the linearly polarized antenna is widely used. However, because the circularly polarized antenna cannot be well polarization-matched to the radio-frequency tag, the read/write distance is reduced and communication quality is poor. In addition, when receiving a wireless signal from a radio-frequency tag in a polarization direction, the linearly polarized antenna has good communication quality. However, because the linearly polarized antenna has poor communication quality when receiving wireless signals from radio-frequency tags in non-polarization directions, the linearly polarized antenna cannot be applied to the scenario in which the radio-frequency tags are located in the plurality of different directions. Therefore, how to keep good communication quality and a long read/write distance for an antenna in the scenario in which the radio-frequency tags are located in the plurality of different directions has become a topic to be urgently resolved.

### SUMMARY

In view of the foregoing, the present invention provides an antenna module and a communication device. The antenna module includes a substrate, a radiation part, and a ground part. The substrate includes a first surface and a second surface opposite to each other. The radiation part is located on the first surface of the substrate. The radiation part includes a first feed point, a second feed point, and four slots. The first feed point and the second feed point are respectively located in a two-dimensional axis direction of the radiation part. Two adjacent ones of the four slots are symmetrical to each other. The ground part is located on the second surface of the substrate.

The communication device includes an antenna module and a transceiver module. The antenna module includes a substrate, a radiation part, and a ground part. The substrate includes a first surface and a second surface opposite to each other. The radiation part is located on the first surface of the substrate. The radiation part includes a first feed point, a second feed point, and four slots. The first feed point and the second feed point are respectively located in a two-dimensional axis direction of the radiation part. Two adjacent ones of the four slots are symmetrical to each other. The ground part is located on the second surface of the substrate. The transceiver module is coupled to the first feed point and the second feed point.

In conclusion, according to some embodiments, the antenna module in the present invention supports operating bandwidths of a frequency band specified by a relevant protocol of radio-frequency identification. The frequency band specified by the relevant protocol of radio-frequency identification is, for example, an FCC (Federal Communications Commission) frequency band (approximately between 902 MHz (Megahertz) and 928 MHz). The antenna module in the present invention can separately transmit a vertical polarization signal and a horizontal polarization signal to a radio-frequency tag, thereby improving read/write efficiency, improving an identification range, increasing a read/write distance, reducing a signal blind area, and enhancing adaptability when a location and a direction of the radio-frequency tag are in a changing environment.

### BRIEF DESCRIPTION OF THE DRAWINGS

FIG. 1 is a three-dimensional schematic diagram of an antenna module according to a first embodiment of the present invention;

FIG. 2 is a schematic top view of an antenna module according to a first embodiment of the present invention;

FIG. 3 is a schematic bottom view of an antenna module according to a first embodiment of the present invention;

FIG. 4 is a schematic diagram of a communication device and application of the communication device according to some embodiments of the present invention;

FIGS. 5A and 5B are schematic diagrams of an antenna module and application of the antenna module according to a first embodiment of the present invention;

FIG. 6 is a schematic diagram of return loss of an antenna module according to a first embodiment of the present invention;

FIG. 7 is a schematic diagram of mutual coupling isolation between a first feed point and a second feed point of an antenna module according to a first embodiment of the present invention;

FIG. 8A is a radiation pattern diagram, in an X-Z plane, of a communication signal generated by exciting an antenna module according to a first embodiment of the present invention at a first feed point;

FIG. 8B is a radiation pattern diagram, in a Y-Z plane, of a communication signal generated by exciting an antenna module according to a first embodiment of the present invention at a first feed point;

FIG. 9A is a radiation pattern diagram, in an X-Z plane, of a communication signal generated by exciting an antenna module according to a first embodiment of the present invention at a second feed point;

FIG. 9B is a radiation pattern diagram, in a Y-Z plane, of a communication signal generated by exciting an antenna module according to a first embodiment of the present invention at a second feed point;

FIG. 10A is a current distribution diagram after an antenna module according to a first embodiment of the present invention is excited at a first feed point;

FIG. 10B is a current distribution diagram after an antenna module according to a first embodiment of the present invention is excited at a second feed point;

FIG. 11 is a schematic diagram of return loss of an antenna module of a comparative example and an antenna module of a first embodiment of the present invention;

FIG. 12 is a schematic diagram of mutual coupling isolation between a first feed point and a second feed point of an antenna module of a comparative example and an antenna module of a first embodiment of the present invention;

FIG. 13 is a schematic diagram of return loss of an antenna module according to a first embodiment of the present invention;

FIG. 14 is a schematic diagram of return loss of an antenna module according to a first embodiment of the present invention;

FIG. 15 is a schematic diagram of mutual coupling isolation between a first feed point and a second feed point of an antenna module according to a first embodiment of the present invention;

FIG. 16 is a schematic diagram of return loss of an antenna module according to a first embodiment of the present invention;

FIG. 17 is a schematic diagram of mutual coupling isolation between a first feed point and a second feed point of an antenna module according to a first embodiment of the present invention;

FIG. 18 is a schematic diagram of return loss of an antenna module according to a first embodiment of the present invention;

FIG. 19 is a schematic top view of an antenna module according to a second embodiment of the present invention;

FIG. 20 is a schematic top view of an antenna module according to a third embodiment of the present invention;

FIG. 21 is a schematic diagram of return loss of an antenna module according to a first embodiment to a third embodiment of the present invention;

FIG. 22 is a schematic diagram of mutual coupling isolation between a first feed point and a second feed point of an antenna module according to a first embodiment to a third embodiment of the present invention;

FIG. 23 is a schematic diagram of antenna gain of an antenna module according to a first embodiment to a third embodiment of the present invention;

FIG. 24 is a schematic top view of an antenna module according to a fourth embodiment of the present invention;

FIG. 25 is a schematic top view of an antenna module according to a fifth embodiment of the present invention;

FIG. 26 is a schematic diagram of return loss of an antenna module according to a first embodiment, a fourth embodiment, and a fifth embodiment of the present invention;

FIG. 27 is a schematic diagram of mutual coupling isolation between a first feed point and a second feed point of an antenna module according to a first embodiment, a fourth embodiment, and a fifth embodiment of the present invention; and

FIG. 28 is a schematic diagram of antenna gain of an antenna module according to a first embodiment, a fourth embodiment, and a fifth embodiment of the present invention.

### DETAILED DESCRIPTION

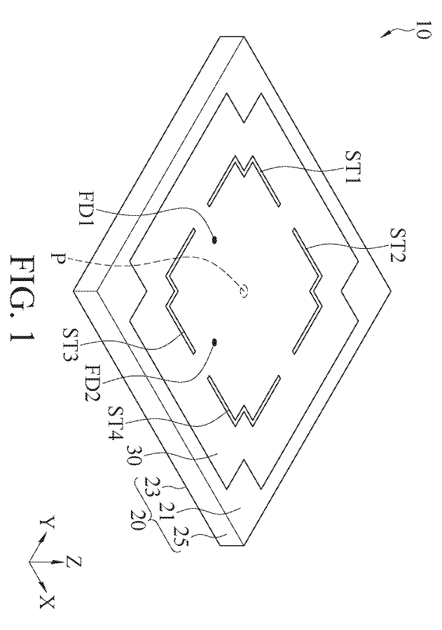

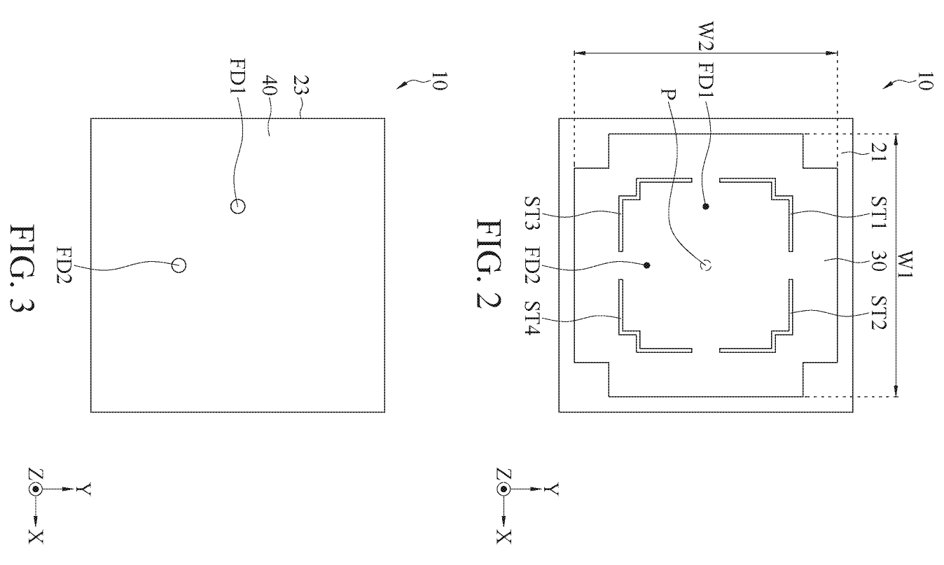

Refer to FIGS. 1, 2, and 3. FIG. 1 is a three-dimensional schematic diagram of an antenna module 10 according to a first embodiment of the present invention. FIG. 2 is a schematic top view of an antenna module 10 according to a first embodiment of the present invention. FIG. 3 is a schematic bottom view of an antenna module 10 according to a first embodiment of the present invention. The antenna module 10 includes a substrate 20, a radiation part 30 and a ground part 40. The substrate 20 includes a first surface 21 and a second surface 23 opposite to each other. The radiation part 30 is located on the first surface 21 of the substrate 20. The ground part 40 is located on the second surface 23 of the substrate 20. In this way, the radiation part 30 and the ground part 40 are separated from each other. Specifically, the first surface 21 and the second surface 23 of the substrate 20 each have a conductive layer. The radiation part 30 is made by processing the conductive layer of the first surface 21 of the substrate 20, and the ground part 40 is made by processing the conductive layer of the second surface 23 of the substrate 20. The foregoing processing includes processing manners such as printing processing and etching processing. In some embodiments, the substrate 20 further includes a body 25, located between the first surface 21 and the second surface 23. The body 25 is, for example, a medium with a dielectric coefficient of 4.4. In this way, the radiation part 30 and the ground part 40 are separated from each other through the body 25. In some embodiments, the substrate 20 is, for example, an FR-4 substrate. In some embodiments, the substrate 20 is a single-layer plate, so that a thickness of the antenna module 10 can be reduced, thereby narrowing the antenna module 10, so that the antenna module 10 can be easily installed.

As shown in FIG. 2, the radiation part 30 includes a first feed point FD1, a second feed point FD2, and four slots (to be specific, a first slot ST1, a second slot ST2, a third slot ST3, and a fourth slot ST4). The first feed point FD1 and the second feed point FD2 penetrate through the substrate 20. The first feed point FD1 is coupled to a signal source through a coaxial cable (not shown in the figure). The second feed point FD2 is coupled to the signal source through a coaxial cable (not shown in the figure). The signal source is, for example, a transceiver module (described in detail below) of a communication device. The first feed point FD1 and the second feed point FD2 are respectively located in a two-dimensional axis direction of the radiation part 30. Specifically, the first feed point FD1 is located in a first-dimensional axis direction (for example, an X axis direction, that is, a horizontal axis direction) of two-dimensional axis directions of the radiation part 30, and the second feed point FD2 is located in a second-dimensional axis direction (for example, a Y axis direction, that is, a vertical axis direction) of the two-dimensional axis directions of the radiation part 30. The first feed point FD1 and the second feed point FD2 alternately receive a same feed signal from the signal source. In this way, the radiation part 30 of the antenna module 10 alternately transmits a first-dimensional polarization signal (for example, a horizontal polarization signal) through the first feed point FD1 and transmits a second-dimensional polarization signal (for example, a vertical polarization signal) through the second feed point FD2. Communication quality can be improved, communication efficiency can be improved, a communication range can be enhanced, a communication distance can be increased, and a signal blind area can be reduced through two-dimensional polarization signals (to be specific, the first-dimensional polarization signal and the second-dimensional polarization signal). Specifically, through the two-dimensional polarization signals, the antenna module 10 of the present invention not only has a characteristic of a circularly polarized antenna of being capable of receiving wireless signals from a plurality of different directions, but also has a characteristic of a linearly polarized antenna of being capable of enhancing the communication distance.

As shown in FIG. 2, the four slots (to be specific, the first slot ST1 to the fourth slot ST4) are separated from each other, and two adjacent ones of the four slots are symmetrical to each other. In some embodiments, the four slots are respectively formed by removing a region of the conductive layer on the first surface 21 of the substrate 20, and the body 25 of the substrate 20 in a corresponding region is exposed. In this way, the antenna module 10 adjusts a current path and current distribution of the radiation part 30 through resonance between the four slots and the radiation part 30, so that the antenna module 10 operates at an operating bandwidth of a frequency band specified by a relevant protocol of radio-frequency identification. The frequency band specified by the relevant protocol of radio-frequency identification is, for example, an FCC frequency band (approximately between 902 MHz and 928 MHz). In addition, mutual coupling impact between the first feed point FD1 and the second feed point FD2 of the antenna module 10 can further be reduced through the resonance between the four slots and the radiation part 30.

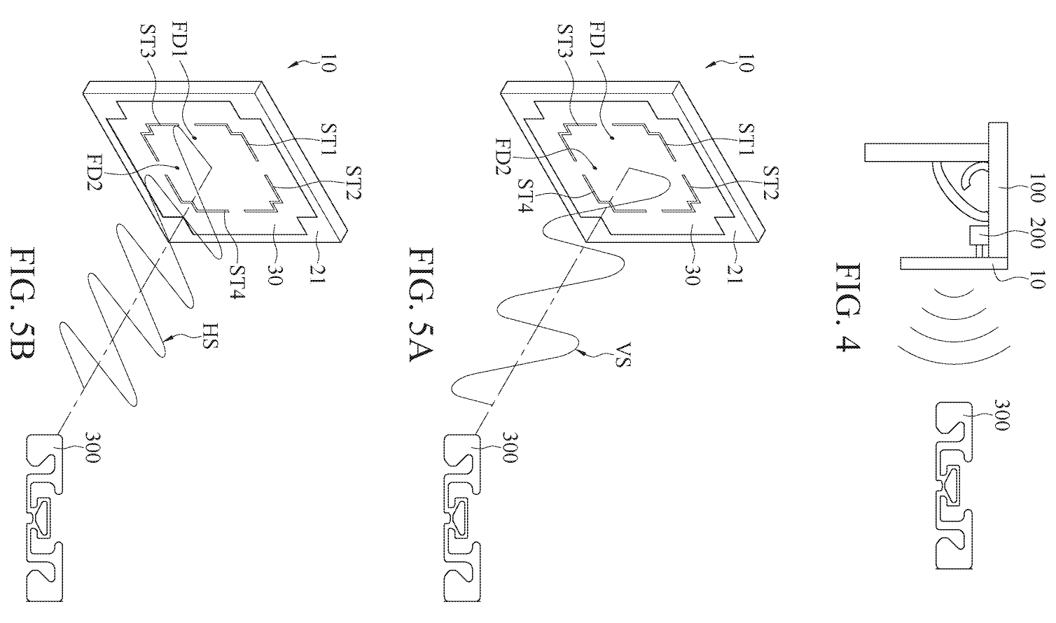

Refer to FIGS. 4, 5A, and 5B. FIG. 4 is a schematic diagram of a communication device 100 and application of the communication device 100 according to some embodiments of the present invention. FIGS. 5A and 5B are schematic diagrams of an antenna module 10 and application of the antenna module 10 according to a first embodiment of the present invention. The communication device 100 includes the antenna module 10 and a transceiver module 200. The transceiver module 200 is coupled to a first feed point FD1 and a second feed point FD2 of the antenna module 10. In some embodiments, the transceiver module 200 is coupled to the first feed point FD1 and the second feed point FD2 of the antenna module 10 through a coaxial cable (not shown in the figure) (specifically, core wires inside the coaxial cable). A ground part 40 (as shown in FIG. 3) of the antenna module 10 is connected to a reference ground terminal (not shown in the figure) of a main board of the communication device 100 through an outer metal surface of the coaxial cable. Outer metal of the coaxial cable is separated from the core wires inside the coaxial cable by an insulation layer. The communication device 100 is, for example, a radio-frequency reader/writer, to read/write a radio-frequency tag 300. A radiation part 30 of the antenna module 10 can transmit a communication signal to the radio-frequency tag 300. For example, the radiation part 30 of the antenna module 10 alternately transmits a first-dimensional polarization signal (for example, a horizontal polarization signal HS) through the first feed point FD1 and transmits a second-dimensional polarization signal (for example, a vertical polarization signal VS) through the second feed point FD2 to the radio-frequency tag 300. Through two-dimensional polarization signals (to be specific, a first-dimensional polarization signal and the second-dimensional polarization signal), read/write quality can be improved, read/write efficiency can be improved, a read/write range can be enhanced (for example, regardless of whether the radio-frequency tag 300 is disposed at a location in a horizontal direction or a location in a vertical direction relative to the communication device 100, the radio-frequency tag 300 can be read/written by the communication device 100), a read/write distance can be increased (for example, compared with read/write distances of a linearly polarized antenna and a circularly polarized antenna, the read/write distance of the antenna module 10 in the present invention can reach at least 5 m (meters)), and a signal blind area can be reduced. In some embodiments, the read/write distance of the antenna module 10 in the present invention in the horizontal direction can be approximately the same as the read/write distance of the antenna module 10 in the vertical direction.

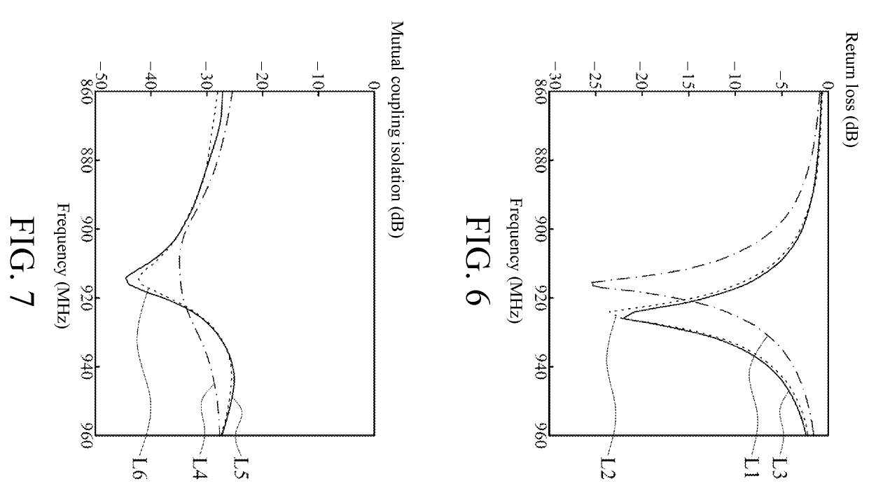

Referring to FIG. 6, FIG. 6 is a schematic diagram of return loss of an antenna module 10 according to a first embodiment of the present invention. A curve L1 is return loss of a communication signal generated by exciting the antenna module 10 at a first feed point FD1 in an ideal condition (and is also return loss of a communication signal generated by exciting the antenna module 10 at a second feed point FD2 in the ideal condition). A curve L2 is return loss of the communication signal generated by exciting the antenna module 10 at the first feed point FD1 in an actual implementation condition. A curve L3 is return loss of the communication signal generated by exciting the antenna module 10 at the second feed point FD2 in the actual implementation condition. It can be seen from FIG. 6 that by means of a structural design of the antenna module 10, in a to-be-covered operating frequency band (for example, an FCC frequency band), the return loss is substantially less than –6 dB (decibel) specified in a related protocol of radio-frequency identification, so that the antenna module 10 features a good antenna characteristic.

Referring to FIG. 7, FIG. 7 is a schematic diagram of mutual coupling isolation between a first feed point FD1 and a second feed point FD2 of an antenna module 10 according to a first embodiment of the present invention. A curve L4 is an interference degree of a communication signal transmitted by the antenna module 10 through excitation of the first feed point FD1 to a communication signal received through excitation of the second feed point FD2 in an ideal condition (and is also an interference degree of a communication signal transmitted by the antenna module 10 through excitation of the second feed point FD2 to a communication signal received through excitation of the first feed point FD1 in the ideal condition). A curve L5 is an interference degree of the communication signal transmitted by the antenna module 10 through excitation of the first feed point FD1 to the communication signal received through excitation of the second feed point FD2 in an actual implementation condition. A curve L6 is an interference degree of the communication signal transmitted by the antenna module 10 through excitation of the second feed point FD2 to the communication signal received through excitation of the first feed point FD1 in the actual implementation condition. It can be seen from FIG. 7 that by means of a structural design of the antenna module 10, in a to-be-covered operating frequency band (for example, an FCC frequency band), the interference degree (that is, a mutual coupling degree) between the first feed point FD1 and the second feed point FD2 is less than –25 dB, which substantially meets a related specification (a loose specification is, for example, that the interference degree is less than –15 dB, and a stricter specification is, for example, that the interference degree is less than a standard value, where the standard value is in a range from –20 dB to –30 dB) of a related protocol of radio-frequency identification, so that the antenna module 10 features good mutual coupling isolation and stability.

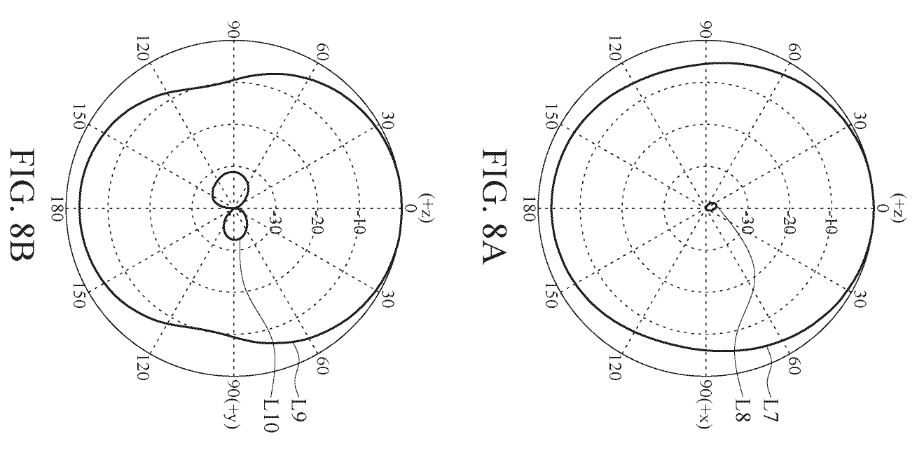

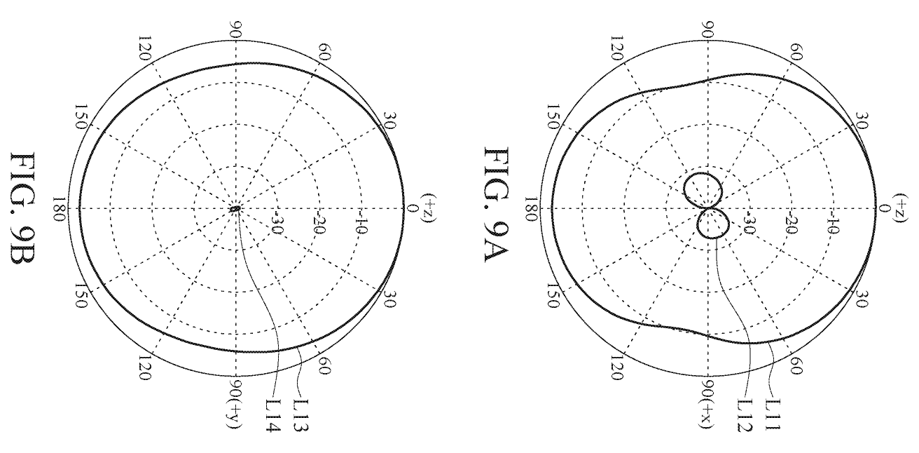

Refer to FIGS. 8A to 9B. FIG. 8A is a radiation pattern diagram, in an X-Z plane, of a communication signal generated by exciting an antenna module 10 according to a first embodiment of the present invention at a first feed point FD1. FIG. 8B is a radiation pattern diagram, in a Y-Z plane, of a communication signal generated by exciting an antenna module 10 according to a first embodiment of the present invention at a first feed point FD1. FIG. 9A is a radiation pattern diagram, in an X-Z plane, of a communication signal generated by exciting an antenna module 10 according to a first embodiment of the present invention at a second feed point FD2. FIG. 9B is a radiation pattern diagram, in a Y-Z plane, of a communication signal generated by exciting an antenna module 10 according to a first embodiment of the present invention at a second feed point FD2. Herein, numbers on a circle are circular degrees, a distance between a curve and a circle center in a radiation pattern corresponds to gain, and a unit of the gain is dB. A curve L7 is a radiation pattern, in a main polarization direction (for example, a horizontal polarization direction) of an X-Z plane, of a communication signal generated by exciting the antenna module 10 at the first feed point FD1. A curve L8 is a radiation pattern, in a cross-polarization direction (which is perpendicular to the main polarization direction, for example, is a vertical polarization direction) of the X-Z plane, of the communication signal generated by exciting the antenna module 10 at the first feed point FD1. A curve L9 is a radiation pattern, in a main polarization direction of a Y-Z plane, of the communication signal generated by exciting the antenna module 10 at the first feed point FD1. A curve L10 is a radiation pattern, in a cross-polarization direction of the Y-Z plane, of the communication signal generated by exciting the antenna module 10 at the first feed point FD1. A curve L11 is a radiation pattern, in the main polarization direction (for example, the vertical polarization direction) of the X-Z plane, of a communication signal generated by exciting the antenna module 10 at the second feed point FD2. A curve L12 is a radiation pattern, in the cross-polarization direction (which is perpendicular to the main polarization direction, for example, is the horizontal polarization direction) of the X-Z plane, of the communication signal generated by exciting the antenna module 10 at the second feed point FD2. A curve L13 is a radiation pattern, in the main polarization direction of the Y-Z plane, of the communication signal generated by exciting the antenna module 10 at the second feed point FD2. A curve L14 is a radiation pattern, in the cross-polarization direction of the Y-Z plane, of the communication signal generated by exciting the antenna module 10 at the second feed point FD2. It can be seen from FIGS. 8A to 9B that, when the antenna module 10 is excited at different feed points, a signal in the main polarization direction corresponding to the antenna module 10 is enhanced and exhibits approximately omnidirectional radiation, and a signal in the cross-polarization direction corresponding to the antenna module 10 is suppressed. In this way, communication efficiency and communication quality can be improved, and a good signal receiving and transmitting capability can be achieved.

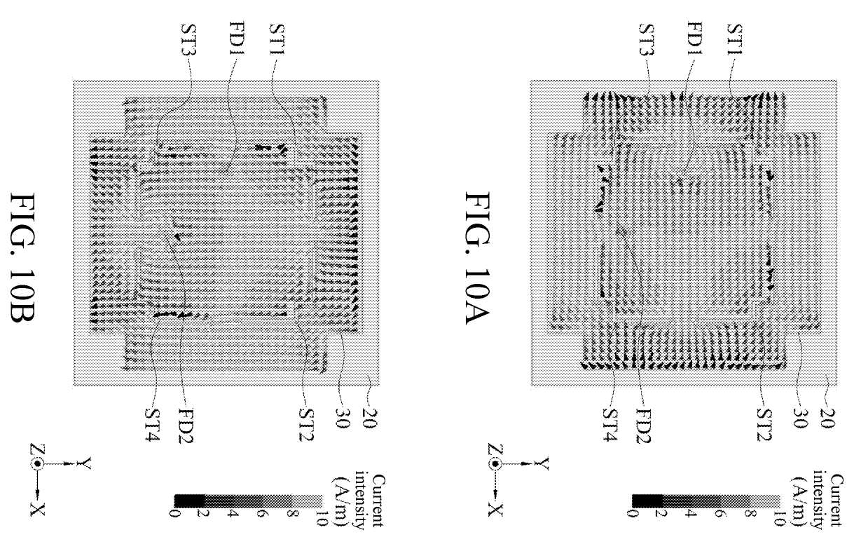

Refer to FIGS. 10A and 10B. FIG. 10A is a current distribution diagram after an antenna module 10 according to a first embodiment of the present invention is excited at a first feed point FD1. FIG. 10B is a current distribution diagram after an antenna module 10 according to a first embodiment of the present invention is excited at a second feed point FD2. It can be seen from FIG. 10A that, when the first feed point FD1 is excited, current flows along an X axis direction, which indicates that excitation of the first feed point FD1 generates a horizontal polarization signal. It can be seen from FIG. 10B that, when the second feed point FD2 is excited, the current flows along a Y axis direction, which indicates that excitation of the second feed point FD2 generates a vertical polarization signal. In this way, it can be seen that excitation of different feed points can stagger current flow directions, and reduce an interference degree between the first feed point FD1 and the second feed point FD2, thereby improving mutual coupling isolation and stability of the antenna module 10.

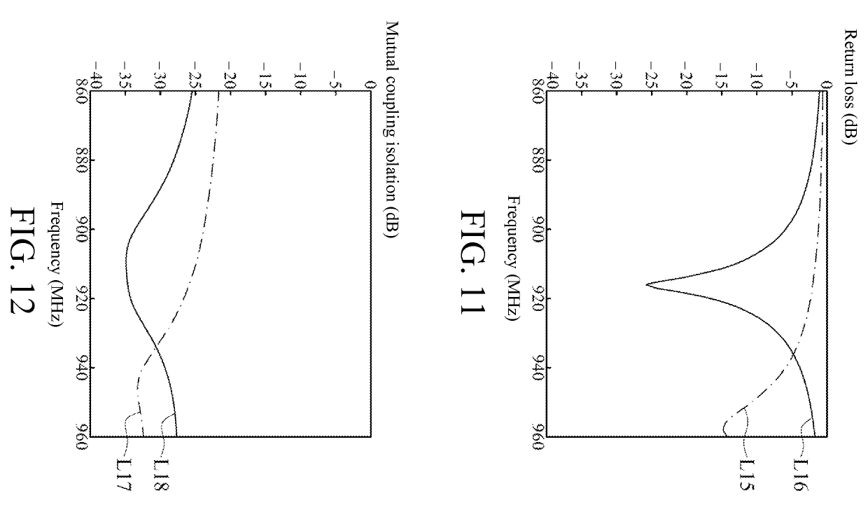

Referring to FIG. 11, FIG. 11 is a schematic diagram of return loss of an antenna module of a comparative example and an antenna module 10 of a first embodiment of the present invention. Herein, a difference between the antenna module of the comparative example and the antenna module 10 of the first embodiment of the present invention lies in that the antenna module of the comparative example does not have four slots (to be specific, a first slot ST1 to a fourth slot ST4). A curve L15 is return loss of a communication signal generated by exciting the antenna module of the comparative example at a first feed point FD1 (is also the return loss of the communication signal generated by exciting the antenna module of the comparative example at a second feed point FD2). A curve L16 is return loss of a communication signal generated by exciting the antenna module 10 of the first embodiment of the present invention at the first feed point FD1 (is also the return loss of the communication signal generated by exciting the antenna module 10 of the first embodiment of the present invention at the second feed point FD2). It can be seen from FIG. 11 that, in the comparative example, in a to-be-covered operating frequency band (for example, an FCC frequency band), the return loss is greater than –6 dB specified in a related protocol of radio-frequency identification. Compared with the antenna module of the comparative example, through the four slots, the antenna module 10 of the first embodiment of the present invention ensures that the return loss in the to-be-covered operating frequency band (for example, the FCC frequency band) is less than –6 dB specified in the related protocol of radio-frequency identification, so that the antenna module 10 features a good antenna characteristic.

Referring to FIG. 12, FIG. 12 is a schematic diagram of mutual coupling isolation between a first feed point FD1 and a second feed point FD2 of an antenna module of a comparative example and an antenna module 10 of a first embodiment of the present invention. Herein, a difference between the antenna module of the comparative example and the antenna module 10 of the first embodiment of the present invention lies in that the antenna module of the comparative example does not have four slots (to be specific, a first slot ST1 to a fourth slot ST4). A curve L17 is an interference degree of a communication signal transmitted by the antenna module of the comparative example through excitation of the first feed point FD1 to a communication signal received through excitation of the second feed point FD2 (is also an interference degree of the communication signal transmitted by the antenna module of the comparative example through excitation of the second feed point FD2 to the communication signal received through excitation of the first feed point FD1). A curve L18 is an interference degree of a communication signal transmitted by the antenna module 10 of the first embodiment of the present invention through excitation of the first feed point FD1 to a communication signal received through excitation of the second feed point FD2 (and is also an interference degree of the communication signal transmitted by the antenna module 10 of the first embodiment of the present invention through excitation of the second feed point FD2 to the communication signal received through excitation of the first feed point FD1). It can be seen from FIG. 12 that, in the comparative example, an interference degree (that is, a mutual coupling degree) between the first feed point FD1 and the second feed point FD2 in a to-be-covered operating frequency band (for example, an FCC frequency band) is greater than –30 dB. Compared with the antenna module of the comparative example, through the four slots, the antenna module 10 of the first embodiment of the present invention ensures that an interference degree between the first feed point FD1 and the second feed point FD2 in the to-be-covered operating frequency band (for example, the FCC frequency band) is less than –25 dB, which substantially meets a related specification (a loose specification is, for example, that the interference degree is less than –15 dB, and a strict specification is, for example, that the interference degree is less than a standard value, where the standard value is in a range from –20 dB to –30 dB) of a related protocol of radio-frequency identification, so that the antenna module 10 features good mutual coupling isolation and stability.

As shown in FIG. 2, in some embodiments, a distance between the first feed point FD1 and an intersection point P of two-dimensional axis directions is the same as a distance between the second feed point FD2 and the intersection point P of the two-dimensional axis directions, to balance impedance matching of two-dimensional polarization signals. In other words, in the antenna module 10, impedance matching of a first-dimensional polarization signal is the same as impedance matching of a second-dimensional polarization signal. In some embodiments, by adjusting the distance between the first feed point FD1 and the intersection point P of the two-dimensional axis directions and the distance between the second feed point FD2 and the intersection point P of the two-dimensional axis directions, the impedance matching of the two-dimensional polarization signals can be adjusted. In some embodiments, the distance between the first feed point FD1 and the intersection point P of the two-dimensional axis directions and the distance between the second feed point FD2 and the intersection point P of the two-dimensional axis directions are respectively between 8 mm (millimeters) and 25 mm. In some other embodiments, the distance between the first feed point FD1 and the intersection point P of the two-dimensional axis directions and the distance between the second feed point FD2 and the intersection point P of the two-dimensional axis directions are respectively between 10 mm and 20 mm. In still some other embodiments, the distance between the first feed point FD1 and the intersection point P of the two-dimensional axis directions and the distance between the second feed point FD2 and the intersection point P of the two-dimensional axis directions are respectively between 14 mm and 17 mm.

Referring to FIG. 13, FIG. 13 is a schematic diagram of return loss of an antenna module 10 according to a first embodiment of the present invention. Because a distance between a first feed point FD1 and an intersection point P of two-dimensional axis directions is the same as a distance between a second feed point FD2 and the intersection point P of the two-dimensional axis directions, only the distance between the first feed point FD1 and the intersection point P of the two-dimensional axis directions is used for description herein. A curve L19 is return loss of the antenna module 10 when the distance between the first feed point FD1 and the intersection point P of two-dimensional axis directions is 11 mm. A curve L20 is return loss of the antenna module 10 when the distance between the first feed point FD1 and the intersection point P of two-dimensional axis directions is 14 mm. A curve L21 is return loss of the antenna module 10 when the distance between the first feed point FD1 and the intersection point P of two-dimensional axis directions is 17 mm. A curve L22 is return loss of the antenna module 10 when the distance between the first feed point FD1 and the intersection point P of two-dimensional axis directions is 20 mm. A curve L23 is return loss of the antenna module 10 when the distance between the first feed point FD1 and the intersection point P of two-dimensional axis directions is 23 mm. It can be seen from FIG. 13 that when the distance between the first feed point FD1 and the intersection point P of the two-dimensional axis directions is 11 mm, 14 mm, 17 mm, 20 mm, or 23 mm, the return loss of the antenna module 10 in a to-be-covered operating frequency band (for example, an FCC frequency band) is substantially less than –6 dB specified in a related protocol of radio-frequency identification, so that the antenna module 10 features a good antenna characteristic.

As shown in FIG. 2, in some embodiments, four slots (to be specific, a first slot ST1 to a fourth slot ST4) are located around the intersection point P of the two-dimensional axis directions. In some embodiments, the intersection point P of the two-dimensional axis directions is a central point of a radiation part 30, to balance impedance matching of two-dimensional polarization signals. In some embodiments, the first slot ST1 and a third slot ST3 are respectively located at two sides of the first feed point FD1, and the third slot ST3 and the fourth slot ST4 are respectively located at two sides of the second feed point FD2.

In some embodiments, lengths of the four slots (to be specific, the first slot ST1 to the fourth slot ST4) are respectively a quarter of a wavelength of a frequency band (specifically, a center frequency, that is, a resonance frequency point, of the frequency band) in which the radiation part 30 operates, to obtain good impedance matching. In some embodiments, impedance matching of the antenna module 10 can be adjusted by adjusting a length-width ratio of each slot. In some embodiments, the length-width ratio of each slot is between 44 and 13.3. For example, a length of each slot is between 40 mm and 44 mm, and a width of each slot is between 1 mm and 3 mm. In some embodiments, lengths of the slots are the same, and widths of the slots are the same. In some embodiments, the width of each slot is inversely proportional to the resonance frequency point of the antenna module 10. In some embodiments, the length of each slot is inversely proportional to the resonance frequency point of the antenna module 10.

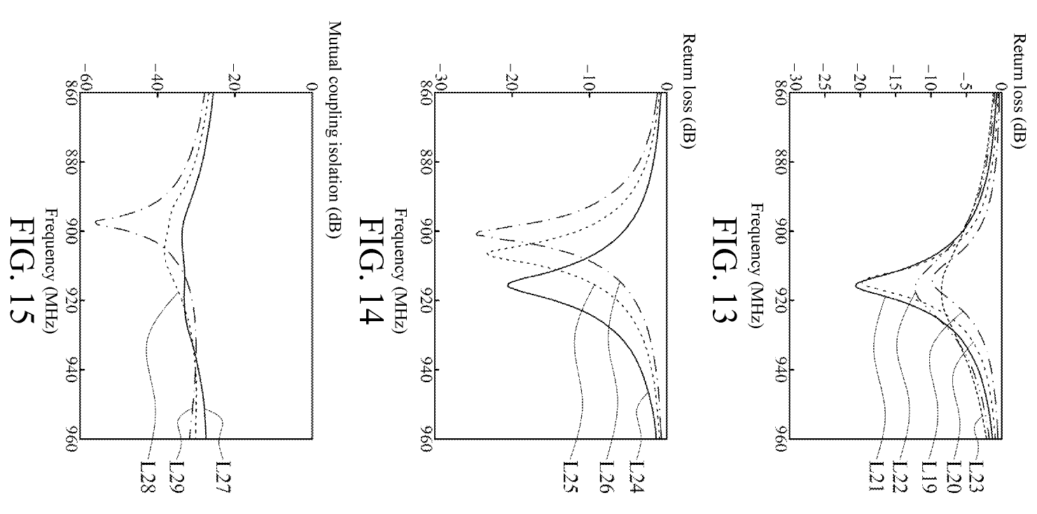

Referring to FIG. 14, FIG. 14 is a schematic diagram of return loss of an antenna module 10 according to a first embodiment of the present invention. Because widths of slots are the same, only a width of a first slot ST1 is used for description herein. A curve L24 is return loss of the antenna module 10 when the width of the first slot ST1 is 1 mm. A curve L25 is return loss of the antenna module 10 when the width of the first slot ST1 is 2 mm. A curve L26 is return loss of the antenna module 10 when the width of the first slot ST1 is 3 mm. It can be seen from FIG. 14 that, when the width of the first slot ST1 is 1 mm, 2 mm, or 3 mm, the return loss of the antenna module 10 in a to-be-covered operating frequency band (for example, an FCC frequency band) is substantially less than –6 dB specified in a related protocol of radio-frequency identification, so that the antenna module 10 features a good antenna characteristic.

Referring to FIG. 15, FIG. 15 is a schematic diagram of mutual coupling isolation between a first feed point FD1 and a second feed point FD2 of an antenna module 10 according to a first embodiment of the present invention. Because widths of slots are the same, only a width of a first slot ST1 is used for description herein. A curve L27 is an interference degree, in a case in which the width of the first slot ST1 is 1 mm, of a communication signal transmitted by the antenna module 10 through excitation of the first feed point FD1 to a communication signal received through excitation of the second feed point FD2 (is also an interference degree, in the case in which the width of the first slot ST1 is 1 mm, of a communication signal transmitted by the antenna module 10 through excitation of the second feed point FD2 to a communication signal received through excitation of the first feed point FD1). A curve L28 is an interference degree, in a case in which the width of the first slot ST1 is 2 mm, of a communication signal transmitted by the antenna module 10 through excitation of the first feed point FD1 to a communication signal received through excitation of the second feed point FD2 (is also an interference degree, in the case in which the width of the first slot ST1 is 2 mm, of a communication signal transmitted by the antenna module 10 through excitation of the second feed point FD2 to a communication signal received through excitation of the first feed point FD1). A curve L29 is an interference degree, in a case in which the width of the first slot ST1 is 3 mm, of a communication signal transmitted by the antenna module 10 through excitation of the first feed point FD1 to a communication signal received through excitation of the second feed point FD2 (is also an interference degree, in the case in which the width of the first slot ST1 is 3 mm, of a communication signal transmitted by the antenna module 10 through excitation of the second feed point FD2 to a communication signal received through excitation of the first feed point FD1). It can be seen from FIG. 15 that, when the width of the first slot ST1 is 1 mm, 2 mm, or 3 mm, the interference degree between the first feed point FD1 and the second feed point FD2 in a to-be-covered operating frequency band (for example, an FCC frequency band) substantially meets a related specification (a loose specification is, for example, that the interference degree is less than –15 dB, and a strict specification is, for example, that the interference degree is less than a standard value, where the standard value is in a range from –20 dB to –30 dB) of a related protocol of radio-frequency identification, so that the antenna module 10 features good mutual coupling isolation and stability.

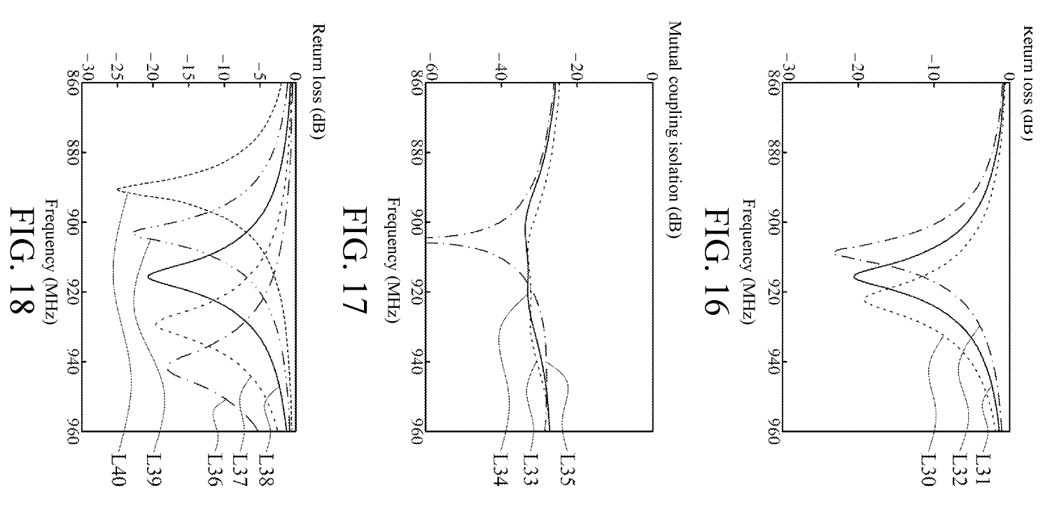

Referring to FIG. 16, FIG. 16 is a schematic diagram of return loss of an antenna module 10 according to a first embodiment of the present invention. Because lengths of slots are the same, only a length of a first slot ST1 is used for description herein. A curve L30 is return loss of the antenna module 10 when the length of the first slot ST1 is 40 mm. A curve L31 is return loss of the antenna module 10 when the length of the first slot ST1 is 42 mm. A curve L32 is return loss of the antenna module 10 when the length of the first slot ST1 is 44 mm. It can be seen from FIG. 16 that, when the length of the first slot ST1 is 40 mm, 42 mm, or 44 mm, the return loss of the antenna module 10 in a to-be-covered operating frequency band (for example, an FCC frequency band) is substantially less than –6 dB specified in a related protocol of radio-frequency identification, so that the antenna module 10 features a good antenna characteristic.

Referring to FIG. 17, FIG. 17 is a schematic diagram of mutual coupling isolation between a first feed point FD1 and a second feed point FD2 of an antenna module 10 according to a first embodiment of the present invention. Because lengths of slots are the same, only a length of a first slot ST1 is used for description herein. A curve L33 is an interference degree, in a case in which the length of the first slot ST1 is 40 mm, of a communication signal transmitted by the antenna module 10 through excitation of the first feed point FD1 to a communication signal received through excitation of the second feed point FD2 (is also an interference degree, in the case in which the length of the first slot ST1 is 40 mm, of a communication signal transmitted by the antenna module 10 through excitation of the second feed point FD2 to a communication signal received through excitation of the first feed point FD1). A curve L34 is an interference degree, in a case in which the length of the first slot ST1 is 42 mm, of a communication signal transmitted by the antenna module 10 through excitation of the first feed point FD1 to a communication signal received through excitation of the second feed point FD2 (is also an interference degree, in the case in which the length of the first slot ST1 is 42 mm, of a communication signal transmitted by the antenna module 10 through excitation of the second feed point FD2 and a communication signal received through excitation of the first feed point FD1). A curve L35 is an interference degree, in a case in which the length of the first slot ST1 is 44 mm, of a communication signal transmitted by the antenna module 10 through excitation of the first feed point FD1 to a communication signal received through excitation of the second feed point FD2 (is also an interference degree, in the case in which the length of the first slot ST1 is 44 mm, of a communication signal transmitted by the antenna module 10 through excitation of the second feed point FD2 to a communication signal received through excitation of the first feed point FD1). It can be seen from FIG. 17 that, when the length of the first slot ST1 is 40 mm, 42 mm, or 44 mm, the interference degree between the first feed point FD1 and the second feed point FD2 in a to-be-covered operating frequency band (for example, an FCC frequency band) substantially meets a related specification (a loose specification is, for example, that the interference degree is less than –15 dB, and a strict specification is, for example, that the interference degree is less than a standard value, where the standard value is in a range from –20 dB to –30 dB) of a related protocol of radio-frequency identification, so that the antenna module 10 features good mutual coupling isolation and stability.

In some embodiments, a size of a radiation part 30 is inversely proportional to a resonance frequency point of an antenna module 10. As shown in FIG. 2, in some embodiments, a length W1 and a width W2 of the radiation part 30 are respectively between 74 mm and 78 mm. In some embodiments, the length W1 of the radiation part 30 is the same as the width W2 of the radiation part 30.

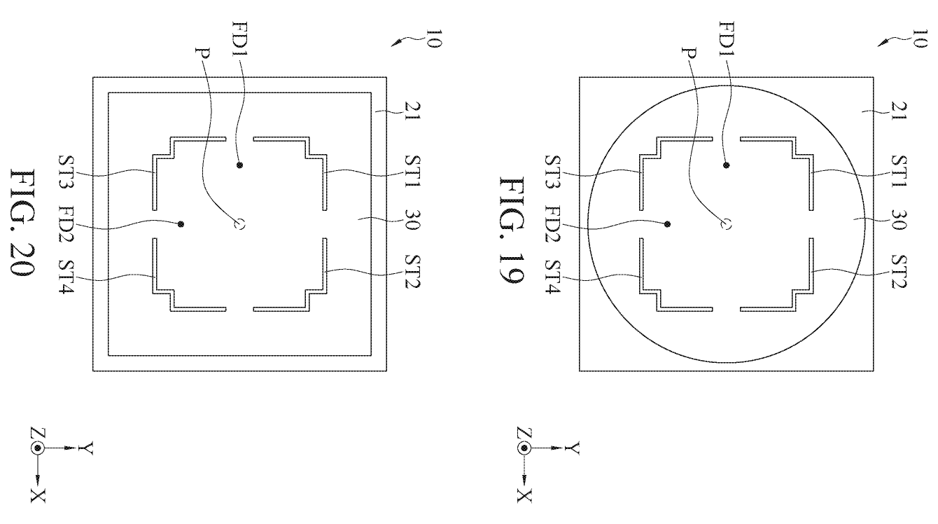

Referring to FIG. 18, FIG. 18 is a schematic diagram of return loss of an antenna module 10 according to a first embodiment of the present invention. Herein, an example in which a length W1 of the radiation part 30 is the same as a width W2 of the radiation part 30 is used, and only the length W1 of the radiation part 30 is used for description. A curve L36 is the return loss of the antenna module 10 when the length W1 of the radiation part 30 is 74 mm. A curve L37 is the return loss of the antenna module 10 when the length W1 of the radiation part 30 is 75 mm. A curve L38 is the return loss of the antenna module 10 when the length W1 of the radiation part 30 is 76 mm. A curve L39 is the return loss of the antenna module 10 when the length W1 of the radiation part 30 is 77 mm. A curve L40 is the return loss of the antenna module 10 when the length W1 of the radiation part 30 is 78 mm. It can be seen from FIG. 18 that, when the length W1 of the radiation part 30 is 74 mm, 75 mm, 76 mm, 77 mm, or 78 mm, the return loss of the antenna module 10 in a to-be-covered operating frequency band (for example, an FCC frequency band) is substantially less than –6 dB specified in a related protocol of radio-frequency identification, so that the antenna module 10 features a good antenna characteristic.

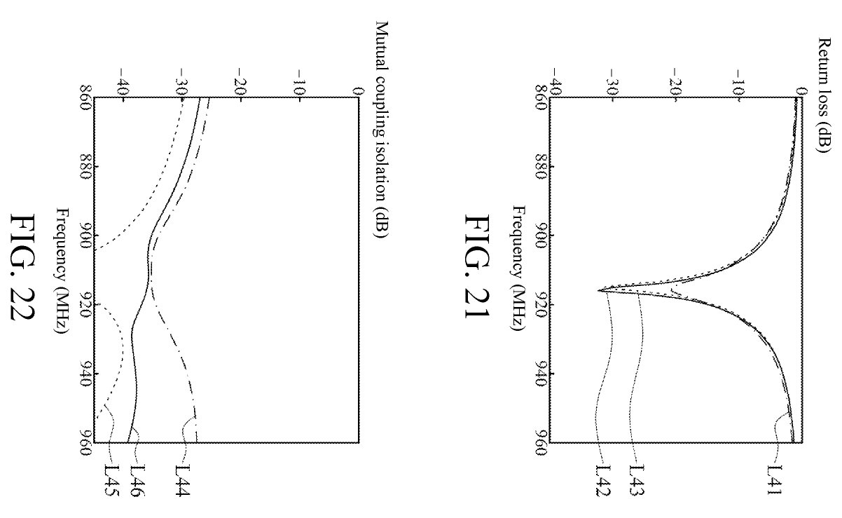

Refer to FIGS. 2, 19 and 20. FIG. 19 is a schematic top view of an antenna module 10 according to a second embodiment of the present invention. FIG. 20 is a schematic top view of an antenna module 10 according to a third embodiment of the present invention. As shown in FIG. 2, in the first embodiment, a shape of the radiation part 30 of the antenna module 10 is a cross shape, to have good antenna gain. Four corners of the cross-shaped radiation part 30 respectively have gaps, and the gaps may be squares or rectangles. However, the present invention is not limited thereto, and the shape of the radiation part 30 may be of any type. For example, as shown in FIG. 19, in the second embodiment, a shape of the radiation part 30 is a circle shape. As shown in FIG. 20, in the third embodiment, a shape of the radiation part 30 is a square shape, to have good impedance matching.

Referring to FIG. 21, FIG. 21 is a schematic diagram of return loss of an antenna module 10 according to a first embodiment to a third embodiment of the present invention. A curve L41 is return loss of the antenna module 10 of the first embodiment of the present invention. A curve L42 is return loss of the antenna module 10 of the second embodiment of the present invention. A curve L43 is return loss of the antenna module 10 of the third embodiment of the present invention. It can be seen from FIG. 21 that, regardless of whether the shape of the radiation part 30 of the antenna module 10 is the cross shape, the circle shape, or the square shape, in a to-be-covered operating frequency band (for example, an FCC frequency band), the return loss is substantially less than –6 dB specified in a related protocol of radio-frequency identification, so that the antenna module 10 features a good antenna characteristic.

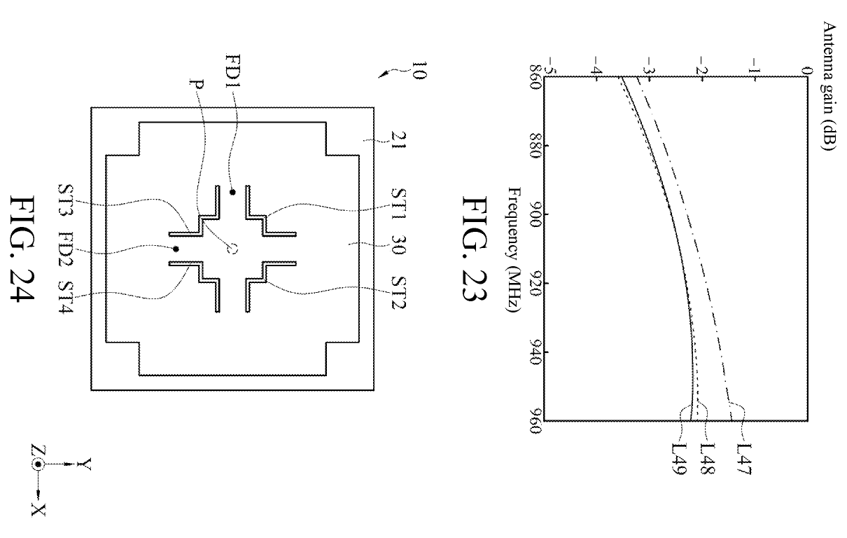

Referring to FIG. 22, FIG. 22 is a schematic diagram of mutual coupling isolation between a first feed point FD1 and a second feed point FD2 of an antenna module 10 according to a first embodiment to a third embodiment of the present invention. A curve L44 is an interference degree between the first feed point FD1 and the second feed point FD2 of the antenna module 10 of the first embodiment of the present invention. A curve L45 is an interference degree between the first feed point FD1 and the second feed point FD2 of the antenna module 10 of the second embodiment of the present invention. A curve L46 is an interference degree between the first feed point FD1 and the second feed point FD2 of the antenna module 10 of the third embodiment of the present invention. It can be seen from FIG. 22 that, regardless of whether a shape of the radiation part 30 of the antenna module 10 is a cross shape, a circle shape, or a square shape, the interference degree (that is, a mutual coupling degree) between the first feed point FD1 and the second feed point FD2 is less than –30 dB, which substantially meets a related specification (a loose specification is, for example, that the interference degree is less than –15 dB, and a strict specification is, for example, that the interference degree is less than a standard value, where the standard value is in a range from –20 dB to –30 dB) of a related protocol of radio-frequency identification, so that the antenna module 10 features good mutual coupling isolation and stability, and provides a good radio-frequency read/write capability.

Referring to FIG. 23, FIG. 23 is a schematic diagram of antenna gain of an antenna module 10 according to a first embodiment to a third embodiment of the present invention. A curve L47 is antenna gain of the antenna module 10 of the first embodiment of the present invention. A curve L48 is antenna gain of the antenna module 10 of the second embodiment of the present invention. A curve L49 is antenna gain of the antenna module 10 of the third embodiment of the present invention. It can be seen from FIG. 23 that, regardless of whether the shape of the radiation part 30 of the antenna module 10 is the cross shape, the circle shape, or the square shape, the antenna module 10 has good antenna gain.

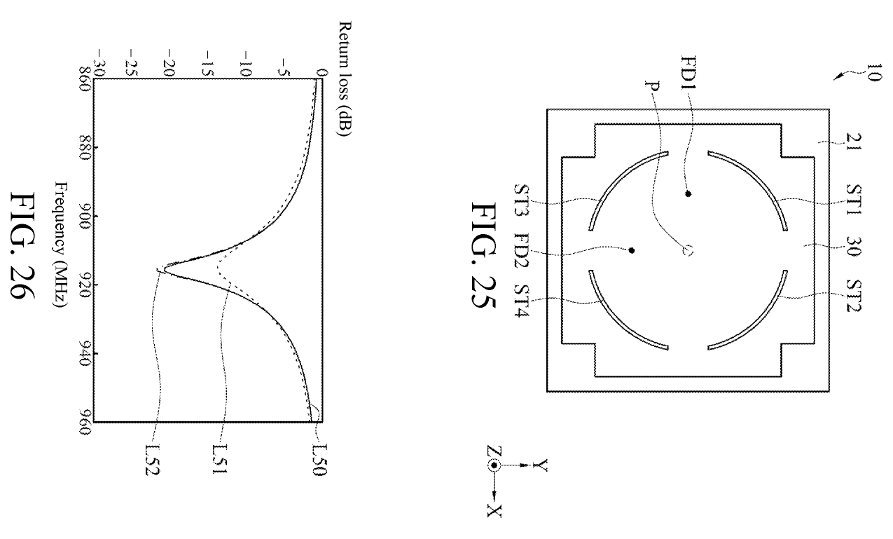

Refer to FIGS. 2, 24, and 25. FIG. 24 is a schematic top view of an antenna module 10 according to a fourth embodiment of the present invention. FIG. 25 is a schematic top view of an antenna module 10 according to a fifth embodiment of the present invention. As shown in FIG. 2, in the first embodiment, each slot of the antenna module 10 extends along a boundary of the radiation part 30 to form an M shape (and a pointed end thereof faces outward the boundary of the radiation part 30). However, the present invention is not limited thereto. Each slot can extend along any direction when two adjacent ones are symmetrical to each other. For example, as shown in FIG. 24, in the fourth embodiment, the radiation part 30 is W-shaped, and a pointed end thereof faces an inner side of a boundary of the radiation part 30. As shown in FIG. 25, in the fifth embodiment, the radiation part 30 is arc-shaped, and a point corresponding to the arc is a central point of the radiation part 30.

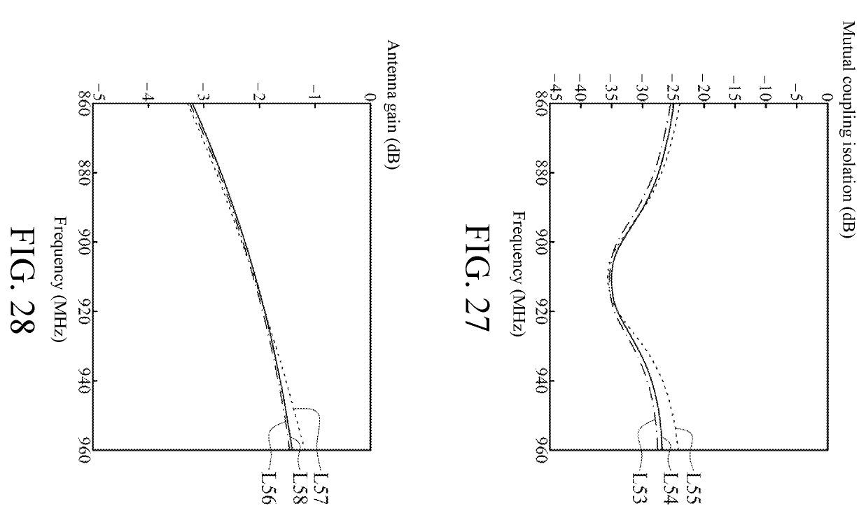

Referring to FIG. 26, FIG. 26 is a schematic diagram of return loss of an antenna module 10 according to a first embodiment, a fourth embodiment, and a fifth embodiment of the present invention. A curve L50 is return loss of the antenna module 10 of the first embodiment of the present invention. A curve L51 is return loss of the antenna module 10 of the fourth embodiment of the present invention. A curve L52 is return loss of the antenna module 10 of the fifth embodiment of the present invention. It can be seen from FIG. 26 that, regardless of whether each slot of the antenna module 10 is W-shaped, M-shaped, or arc-shaped, in a to-be-covered operating frequency band (for example, an FCC frequency band), the return loss is substantially less than –6 dB specified by a related protocol of radio-frequency identification, so that the antenna module 10 features a good antenna characteristic.

Referring to FIG. 27, FIG. 27 is a schematic diagram of mutual coupling isolation between a first feed point FD1 and a second feed point FD2 of an antenna module 10 according to a first embodiment, a fourth embodiment, and a fifth embodiment of the present invention. A curve L53 is an interference degree between the first feed point FD1 and the second feed point FD2 of the antenna module 10 of the first embodiment of the present invention. A curve L54 is an interference degree between the first feed point FD1 and the second feed point FD2 of the antenna module 10 of the fourth embodiment of the present invention. A curve L55 is an interference degree between the first feed point FD1 and the second feed point FD2 of the antenna module 10 of the fifth embodiment of the present invention. It can be seen from FIG. 27 that, regardless of whether each slot of the antenna module 10 is W-shaped, M-shaped, or arc-shaped, the interference degree (that is, a mutual coupling degree) between the first feed point FD1 and the second feed point FD2 is less than –30 dB, which substantially meets a related specification (a loose specification is, for example, that the interference degree is less than –15 dB, and a strict specification is, for example, that the interference degree is less than a standard value, where the standard value is in a range from –20 dB to –30 dB) of a related protocol of radio-frequency identification, so that the antenna module 10 features good mutual coupling isolation and stability, and provides a good radio-frequency read/write capability.

Referring to FIG. 28, FIG. 28 is a schematic diagram of antenna gain of an antenna module 10 according to a first embodiment, a fourth embodiment, and a fifth embodiment of the present invention. A curve L56 is antenna gain of the antenna module 10 of the first embodiment of the present invention. A curve L57 is antenna gain of the antenna module 10 of the fourth embodiment of the present invention. A curve L58 is antenna gain of the antenna module 10 of the fifth embodiment of the present invention. It can be learned from FIG. 28 that, regardless of whether each slot of the antenna module 10 is W-shaped, M-shaped, or arc-shaped, the antenna module 10 has good antenna gain.

In conclusion, according to some embodiments, the antenna module in the present invention supports operating bandwidths of a frequency band specified by a relevant protocol of radio-frequency identification. The frequency band specified by the relevant protocol of radio-frequency identification is, for example, an FCC frequency band (approximately between 902 MHz and 928 MHz). The antenna module in the present invention can separately transmit a vertical polarization signal and a horizontal polarization signal to a radio-frequency tag, thereby improving read/write efficiency, improving an identification range, increasing a read/write distance, reducing a signal blind area, and enhancing adaptability when a location and a direction of the radio-frequency tag are in a changing environment.

What is claimed is:

1. An antenna module, comprising:
a substrate, comprising a first surface and a second surface opposite to each other;
a radiation part, located on the first surface of the substrate, the radiation part comprising a first feed point, a second feed point, and four slots, the first feed point and the second feed point being respectively located in a two-dimensional axis direction of the radiation part, and two adjacent ones of the four slots being symmetrical to each other; and
a ground part, located on the second surface of the substrate.

2. The antenna module according to claim 1, wherein a distance between the first feed point and an intersection point of two-dimensional axis directions is the same as a distance between the second feed point and the intersection point of the two-dimensional axis directions.

3. The antenna module according to claim 1, wherein the four slots are located around an intersection point of two-dimensional axis directions.

4. The antenna module according to claim 3, wherein the intersection point of the two-dimensional axis directions is a central point of the radiation part.

5. The antenna module according to claim 2, wherein the intersection point of the two-dimensional axis directions is a central point of the radiation part.

6. The antenna module according to claim 2, wherein the distance between the first feed point and the intersection point of the two-dimensional axis directions and the distance between the second feed point and the intersection point of the two-dimensional axis directions are respectively between 8 mm and 25 mm.

7. The antenna module according to claim 6, wherein the distance between the first feed point and the intersection point of the two-dimensional axis directions and the distance between the second feed point and the intersection point of the two-dimensional axis directions are respectively between 10 mm and 20 mm.

8. The antenna module according to claim 7, wherein the distance between the first feed point and the intersection point of the two-dimensional axis directions and the distance between the second feed point and the intersection point of the two-dimensional axis directions are respectively between 14 mm and 17 mm.

9. The antenna module according to claim 1, wherein lengths of the four slots are respectively a quarter of a wavelength of a frequency band in which the radiation part operates.

10. The antenna module according to claim 1, wherein a length-width ratio of each slot is from 44 to 13.3.

11. A communication device, comprising:
an antenna module, comprising:
a substrate, comprising a first surface and a second surface opposite to each other;
a radiation part, located on the first surface of the substrate, the radiation part comprising a first feed point, a second feed point, and four slots, the first feed point and the second feed point being respectively located in a two-dimensional axis direction of the radiation part, and two adjacent ones of the four slots being symmetrical to each other; and
a ground part, located on the second surface of the substrate; and
a transceiver module, coupled to the first feed point and the second feed point.

12. The communication device according to claim 11, wherein a distance between the first feed point and an intersection point of two-dimensional axis directions is the same as a distance between the second feed point and the intersection point of the two-dimensional axis directions.

13. The communication device according to claim 11, wherein the four slots are located around an intersection point of two-dimensional axis directions.

14. The communication device according to claim 13, wherein the intersection point of the two-dimensional axis directions is a central point of the radiation part.

15. The communication device according to claim 12, wherein the intersection point of the two-dimensional axis directions is a central point of the radiation part.

16. The communication device according to claim 12, wherein the distance between the first feed point and the intersection point of the two-dimensional axis directions and the distance between the second feed point and the intersection point of the two-dimensional axis directions are respectively between 8 mm and 25 mm.

17. The communication device according to claim 16, wherein the distance between the first feed point and the intersection point of the two-dimensional axis directions and the distance between the second feed point and the intersection point of the two-dimensional axis directions are respectively between 10 mm and 20 mm.

18. The communication device according to claim 17, wherein the distance between the first feed point and the intersection point of the two-dimensional axis directions and the distance between the second feed point and the intersection point of the two-dimensional axis directions are respectively between 14 mm and 17 mm.

19. The communication device according to claim 11, wherein lengths of the four slots are respectively a quarter of a wavelength of a frequency band in which the radiation part operates.

20. The communication device according to claim 11, wherein a length-width ratio of each slot is from 44 to 13.3.
